(19) United States
(12) Patent Application Publication
(10) Pub. No.: US 2019/0203826 A1
(43) Pub. Date: Jul. 4, 2019

(54) TRANSMISSION SHIFTER ASSEMBLY WITH SECONDARY SHIFTING

(71) Applicant: Dura Operating, LLC, Auburn Hills, MI (US)

(72) Inventors: Joseph D. Jiran, Fremont, MI (US); Randy P. Phinney, Grant, MI (US)

(21) Appl. No.: 15/856,540

(22) Filed: Dec. 28, 2017

(51) Int. Cl. F16H 59/02; F16H 61/32; F16H 61/22; F16H 61/18; F16H 59/10

(52) U.S. Cl. CPC F16H 59/0278; F16H 61/32; G05G 5/04; F16H 61/18; F16H 59/105; F16H 61/22

(57) ABSTRACT

At least some implementations of a transmission gear shifter include a shifter for a vehicle transmission that includes a first shift member, a retainer, an actuator and a second shift member. The first shift member has a body rotatable about an axis among multiple positions, and the retainer is movable relative to the body between a first position in which the retainer prevents movement of the body and a second position in which the retainer permits movement of the body. The actuator is coupled to the retainer to drive the retainer between the first position and second position. The second shift member is coupled to the retainer for movement with the retainer relative to the body, and arranged to selectively engage and rotate the body.

### TECHNICAL FIELD

The present disclosure relates generally to a gear shift system for a vehicle transmission.

### BACKGROUND

In some vehicles, a gear shift lever in a passenger compartment of the vehicle can be moved by an operator of the vehicle to shift the vehicle transmission between its park gear and other gears, such as reverse, neutral and forward drive gears. The shift lever is mechanically coupled to the transmission through a cable that transmits the shift lever movement to a transmission shift mechanism. Other vehicles use a so-called “shift-by-wire” system wherein an operator shift lever or shift control unit is not physically coupled to the transmission shift mechanism by a cable. Instead, the shift control unit is electrically coupled to a shift actuator that is arranged to shift the transmission upon receipt of a signal from the shift control unit that a transmission gear shift is desired by the operator. It may be desirable, in at least some circumstances, to selectively prevent movement of the shift lever to prevent shifting the transmission at least until certain conditions are satisfied. For example, to shift the transmission out of park, a vehicle brake may need to be depressed or some other driver action may be needed. In some instances, it may be desirable to shift the transmission without a user command to do so.

### SUMMARY

At least some implementations of a transmission gear shifter include a shifter for a vehicle transmission that includes a first shift member, a retainer, an actuator and a second shift member. The first shift member has a body rotatable about an axis among multiple positions, and the retainer is movable relative to the body between a first position in which the retainer prevents movement of the body and a second position in which the retainer permits movement of the body. The actuator is coupled to the retainer to drive the retainer between the first position and second position. The second shift member is coupled to the retainer for movement with the retainer relative to the body, and arranged to selectively engage and rotate the body.

In at least some implementations, the second shift member is integral with the retainer and is moved along the same path as the retainer to engage and rotate the body in at least some positions of the retainer and body. The retainer may include a body and the second shift member may be defined by a surface of the body. The body may include an engagement surface arranged to be selectively engaged by the second shift member in at least one position of the body and in at least one position of the retainer.

In at least some implementations, the second shift member is a gear that is moved relative to the body as the retainer moves and which is selectively rotated to rotate the body. In this regard, the body may include teeth and the second gear may likewise include teeth that are selectively meshed with the teeth of the body.

In at least some implementations, a drive gear is rotated by the actuator and a driven gear is driven by the drive gear, and the driven gear may be coupled to the retainer to move the retainer relative to the body and relative to the drive gear. A clutch may be coupled to the driven gear to selectively prevent rotation of the drive gear. And the clutch may be coupled to the retainer and to the driven gear so that, in at least one position of the retainer, the clutch prevents rotation of the driven gear and in at least one other position of the retainer the driven gear rotates.

In at least some implementations, the shifter includes a drive assembly having multiple gears arranged in a torque path between the actuator and the retainer to move the retainer relative to the body, and wherein at least one of the multiple gears is fixed to the retainer. At least one of the multiple gears may be formed integrally with a body of the retainer 15. And the multiple gears may include at least two gears that provide an increase in the torque provided by the actuator.

In at least some implementations, the retainer and body include control features that are radially overlapped relative to the axis when the retainer is in the first position so that the retainer prevents rotation of the first shift member and are not radially overlapped when the retainer is in the second position so that the retainer does not prevent rotation of the first shift member. In this way, the retainer may be used to selectively prevent rotation of the first shift member.

In at least some implementations, a shifter for a vehicle transmission includes a first shift member, a retainer, an actuator, a drive and a second shift member. The first shift member has a body rotatable about an axis among multiple positions. The retainer is movable relative to the body between a first position in which the retainer prevents movement of the body and a second position in which the retainer permits movement of the body. The drive is coupled to the actuator and to the retainer to drive the retainer between the first position and second position. And the second shift member is carried by the retainer for movement with the retainer relative to the body, and arranged to selectively engage and rotate the body.

In at least some implementations, the drive includes a drive gear directly driven by the actuator and a driven gear fixed to the retainer so that rotation of the drive gear causes linear translation of the retainer. During linear translation of the retainer, the drive gear may translate relative to the drive gear but does not rotate. A clutch may be coupled to the driven gear to prevent rotation of the driven gear in at least some positions of the retainer.

### BRIEF DESCRIPTION OF THE DRAWINGS

The following detailed description of some implementations of a shifter will be set forth with regard to the accompanying drawings, in which:

FIG. 1 is a top perspective view of a transmission gear shifter assembly with a rotary selector;

FIG. 2 is a side view of the shifter of FIG. 1 with a housing and some other components removed to show certain internal components including the selector, a circuit board, a second shift member, a retainer and an actuator;

FIG. 3 is a top perspective view of a portion of a first shift member, a shift position retainer and secondary shift member;

FIG. 4 is an enlarged perspective view of a portion of FIG. 3;

FIG. 5 is a perspective view similar to FIG. 3 with a second body of the first shift member shown transparent to illustrate features beneath the second body;

FIG. 6 is a top view of the components shown in FIG. 5 when the first shift member is in a first position and the retainer is in a first position;

FIG. 7 is an enlarged, fragmentary perspective view of a portion of FIG. 6;

FIG. 8 is a top view similar to FIG. 6 showing the first shift member in the first position and the retainer in a second position;

FIG. 9 is an enlarged, fragmentary perspective view of a portion of FIG. 8;

FIG. 10 is a top view similar to FIG. 6 showing the first shift member in a second position and the retainer in the second position;

FIG. 11 is a top view similar to FIG. 10 showing the first shift member in a third position and the retainer in the first position;

FIG. 12 is a top view similar to FIG. 11 showing the retainer in the second position;

FIG. 13 is a top view similar to FIG. 12 showing the first shift member in a fourth position and the retainer in the second position;

FIG. 14 is a top view similar to FIG. 13 showing the first shift member in a fourth position and the retainer in a third position in which secondary shifting may occur;

FIG. 15 is a top view similar to FIG. 14 showing the first shift member in the first position and the retainer in the third position after secondary shifting of the first shift member;

FIG. 16 is a fragmentary sectional view of a clutch mechanism associated with the secondary shift member;

FIG. 17 is a fragmentary perspective view of a portion of the clutch mechanism;

FIG. 18 is a perspective view of a portion of a shifter assembly having a second body of a first shift member shown transparent to illustrate features of a shift position retainer and secondary shift member beneath the second body;

FIG. 19 is a top view of the components shown in FIG. 18 when the first shift member is in a first position and the retainer is in a first position;

FIG. 20 is an enlarged, fragmentary perspective view of a portion of FIG. 19;

FIG. 21 is a top view similar to FIG. 19 showing the first shift member in the first position and the retainer in a second position;

FIG. 22 is a top view similar to FIG. 21 showing the first shift member in a third position and the retainer in the first position;

FIG. 23 is a top view similar to FIG. 22 showing the retainer in the second position;

FIG. 24 is a top view similar to FIG. 23 showing the first shift member in a fourth position and the retainer in the second position;

FIG. 25 is a top view similar to FIG. 24 showing the first shift member in a fourth position and the retainer in a third position in which secondary shifting may occur;

FIG. 26 is a top view similar to FIG. 25 showing the first shift member in the first position and the retainer in the third position after secondary shifting of the first shift member;

### DETAILED DESCRIPTION

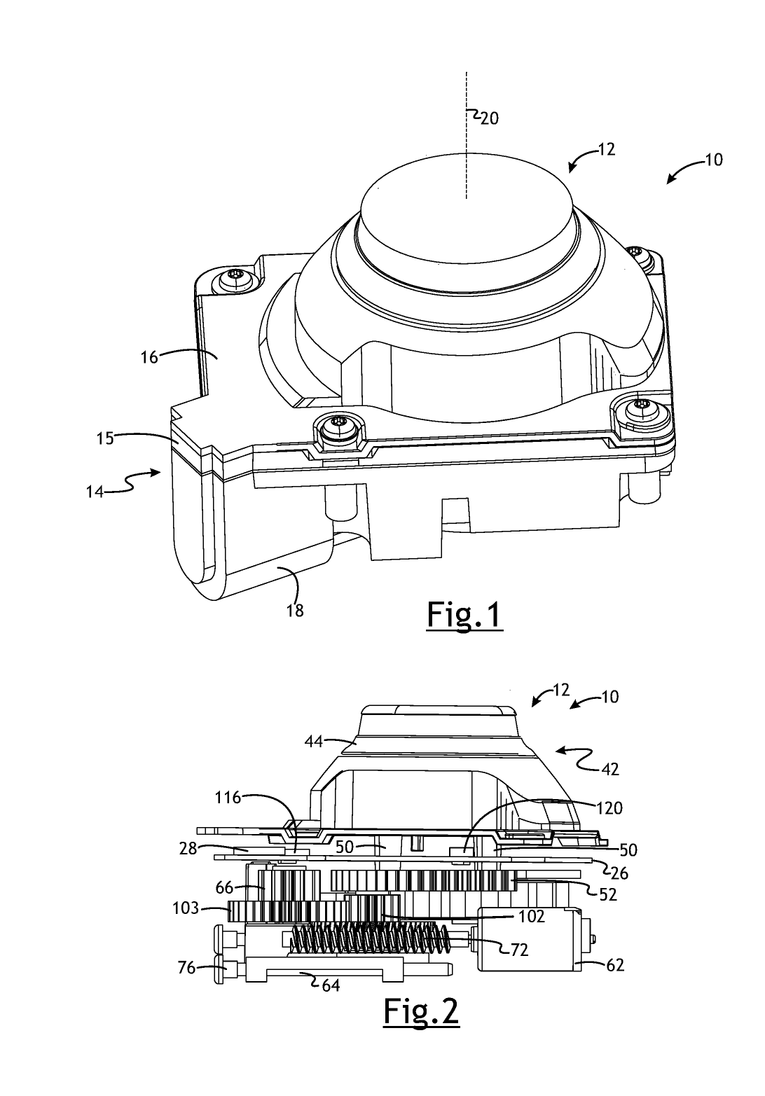

Referring in more detail to the drawings, FIGS. 1 and 2 illustrate a rotary gear shifter 10 that may be used to shift among various gears of a transmission. In at least some implementations, the shifter 10 is not directly mechanically coupled to the transmission and instead communicates electrically with an actuator coupled to the transmission that, in turn, causes a change in the selected transmission gear in a so-called shift-by-wire system. The shifter 10 may include a first shift member, such as a dial, knob or other rotary selector 12, that may be manually rotated by a user through multiple positions corresponding to multiple gears of the vehicle transmission. By way of non-limiting examples, the selector 12 may include and be rotated to one or more positions that correspond to park, reverse, neutral and drive gears for a vehicle transmission.

The selector 12 may be mounted to a housing 14 (only part of which is shown to better illustrate internal components) that is arranged to be mounted within a vehicle. The housing 14 may have an upper portion 15, a cover 16 (FIGS. 1 and 2) over the upper portion and surrounding the selector 12 and a base 18 coupled to the upper portion 15 and/or cover to define an at least partial enclosure for the selector 12 and related shifter components, as set forth below. The selector 12 may be carried by the housing 14 for rotation relative to the housing about a central axis 20. And so that the selector may be manually actuated by a user to cause a transmission gear change, the selector 12 may extend at least partially out of the cover 16.

As shown in FIG. 2, within the enclosure, the shifter 10 may include a circuit board 26 on which one or more circuit elements, such as a microprocessor or controller 28, may be mounted. In at least some implementations, the circuit board 26 is generally planar and is mounted perpendicularly to the axis 20 of rotation of the selector 12. If desired, a gasket or other seals may be provided between the cover 16 and the circuit board 26. For example, a gasket may be provided between the flange 24 of the cover 16 and the circuit board 26. The gasket and/or other seals may help to isolate the circuit elements on the circuit board 26 from liquids and other contaminants, if desired.

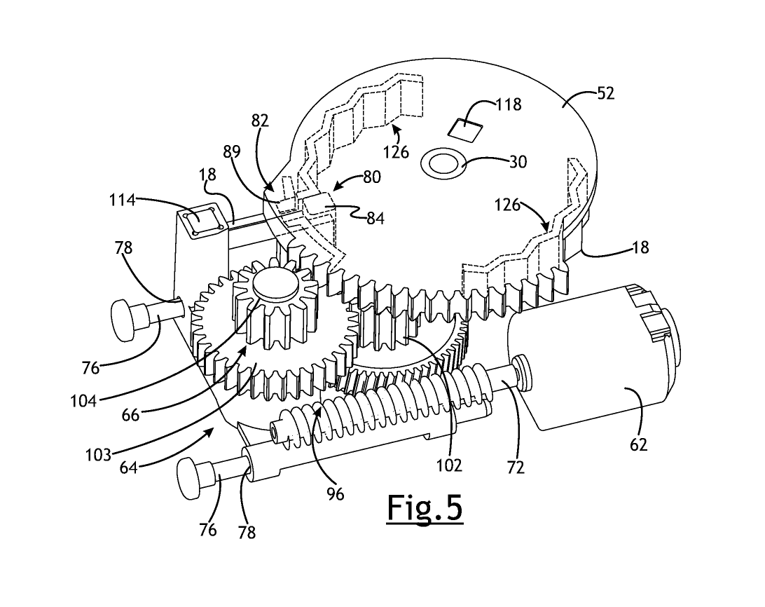

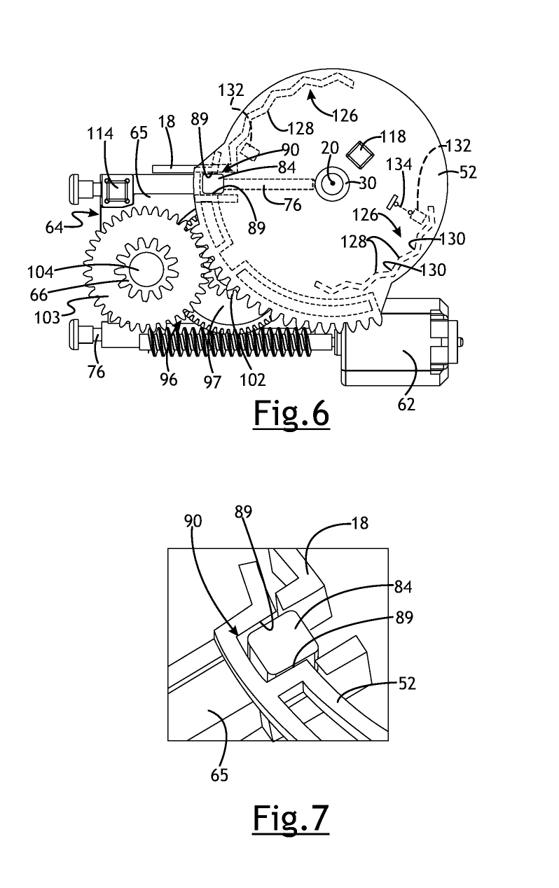

The housing base 18, or at least a portion thereof, is shown in FIGS. 1 and 5, 6, 8 and 10-14 (where only small portions are shown in some figures). The base 18 may include a post 30 (See e.g. FIGS. 5 and 6) about which part of the selector 12 is received and which may help guide the rotation of the selector 12, and other features to mount or interact with various components within the housing 14, as will be discussed below.

As shown in FIGS. 1 and 2, the selector 12 may include a user actuated first body 42 that may include or be coupled to a decorative cover 44 that is fixed to the first body for co-rotation with the first body. The first body 42 may include a cavity or open space in which one or more buttons, lights, wires or other devices and things may be mounted on or adjacent to the column. The buttons may permit some shifting of the transmission (e.g. manual upshifts and downshifts in a sport mode), selection of infotainment system functions (e.g. radio, navigation and the like), and/or selection of other vehicle functions (e.g. heating and cooling settings). The light or lights may provide illumination of certain features of the selector 12, such as various indicia or features used to indicate the various positions of the selector.

The first body 42 may also include one or more legs 50 (FIG. 2) that extend axially from the first body and are coupled to a second body 52, for co-rotation of the first body 42 and second body 52. This provides some space between the first and second bodies 42, 52 in which components may be received. Of course, the legs 50 and provided space between the first and second bodies 42, 52 are not necessary and any such components can be provided within the cavity of the first body or not at all, as desired.

The second body 52 may be fixed to the legs 50 or some other portion of the first body 42 for co-rotation with the first body. The second body 52 may be mounted to the housing 14, such as by the post 30 that extends into or through a central opening 54 (see e.g. FIGS. 5 and 6) in the second body 52 so that the second body (and connected first body) rotate relative to the post and housing. In the example shown, the second body 52 is disc-shaped, with an upper face 56 facing the first body 42, a lower face 58 that faces in the opposite direction (e.g. toward the base 18 of the housing 14) and an axially and circumferentially extending sidewall 60 at the radial outer surface of the second body 52.

Further, the circuit board 26 may extend between the first and second bodies 42, 52 of the selector 12, with the legs 50 extending through holes in the circuit board, or located outboard (e.g. adjacent to side edges) of the circuit board. A portion of the upper housing 16 may also extend between the first and second bodies 42, 52 of the selector 12 to facilitate rotary mounting of the selector. In addition to or instead of these things, the electronic controller 28, which may include a microprocessor, could be received within the cavity of the first body. The controller 28 may be used to manage the operation of the shifter 10 including any buttons, lights or other features provided with the shifter, if desired. With portions of the selector 12 on either side of the circuit board 26, various electronic components may be located in close proximity to different portions of the selector to facilitate electrical coupling of the components to the circuit board 26 and controller 28.

An actuator 62 may be provided to drive one or both of a shift position retainer 64 and a second shift member 66. As set forth in more detail below, the retainer 64 may selectively block rotation of the selector 12 and the second shift member 66 may be driven in certain circumstances to rotate the selector 12 and cause a transmission gear change without user actuation of the selector. In the example shown, the actuator 62 is carried by the housing base 18.

In at least some implementations, the actuator 62 may be any desired form of rotary or linear actuator suitable to move the retainer 64 relative to the second body 52 as set forth below. In the example shown, the actuator is a reversible electric motor 62 with a rotary drive shaft 70 (FIG. 4). The drive shaft 70 is coupled to a drive member 72 that is coupled to and drives the retainer 64. In the example shown, the drive member is a cylindrical spindle 72 that has one or more outwardly extending threads 74. The spindle may be a helical gear, acme screw, lead screw or other device and may generally be called a gear or spindle herein. When the drive shaft 70 and spindle 72 are rotated in a first direction the retainer 64 is moved away from the motor 62, and when the drive shaft 70 and spindle 72 are rotated in a second direction the retainer 64 is moved toward the motor 62. The motor 62 may be controlled and actuated by the controller 28 on the circuit board 26 or by a different vehicle controller, as desired. While described with regard to linear motion, the retainer 64 could instead be rotated by the actuator, or moved along a path of some other shape, as desired.

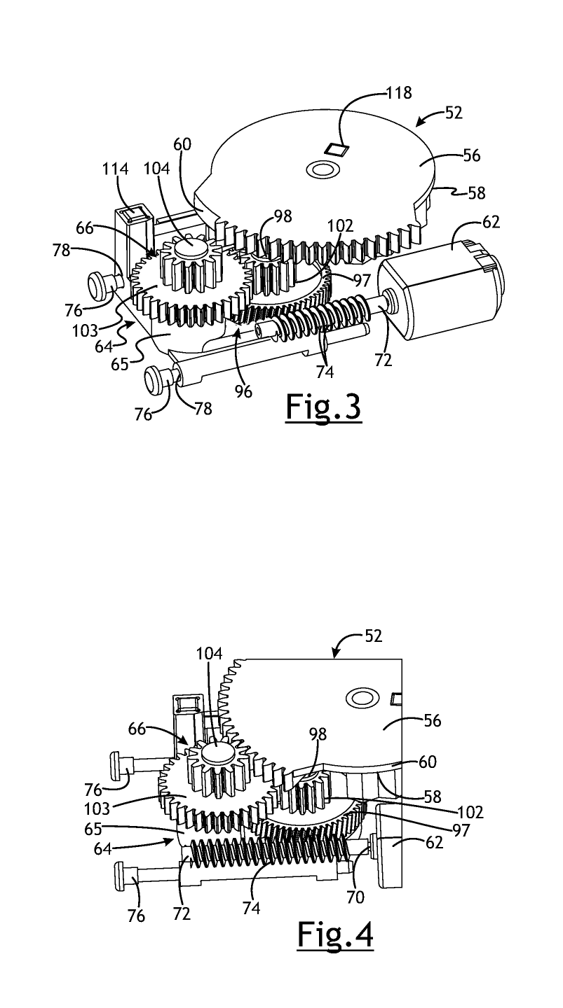

As shown in FIGS. 3-5 among others, in at least some implementations, the housing 14 may include or carry one or more guide members 76 that extends at least part of the way between the actuator 62 and toward the second body 52. The retainer 64 may be slidably moved along a linear path defined by the guide members 76 and relative to the second body 52. The guide members 76 may be defined by one or more posts or rods that are integrally formed in or otherwise carried by the base 18. In the examples shown, the guide members 76 are defined by two rods and the retainer main body 65 includes two spaced apart passages 78 which each receive a respective one of the guide members 76 for linear movement of the retainer 64 along the guide members 76. Accordingly, the rotary motion of the spindle 72 causes linear movement of the retainer 64. Hence, the retainer 64 may include a body 65 that extends between the guide members 76.

As shown in FIGS. 5-9, to control rotation of the second body 52 and hence, the selector 12, the retainer 64 may include one or more control features 80 that interact with control features 82 provided on the selector (e.g. the second body 52). The retainer control features 80 and selector control features 82 cooperate to inhibit or prevent rotation of the selector 12 in certain positions or the selector and/or in certain operating circumstances. For example, the retainer 64 may be positioned so that one or more of its control features 80 overlap one or more selector control surfaces 82 to prevent rotation of the second body 52 when the selector 12 is in the position corresponding to the transmission being in park. To shift the transmission out of park, a driver may have to take some action before rotating the selector 12, such as applying a vehicle brake. Upon detection that the vehicle brake has been applied, the actuator 62 may be energized to drive the retainer 64 to a position in which the retainer control features 80 are not overlapped with the selector control features 82 so that the second body 52 may be rotated relative to the retainer 64.

Similarly, in some instances, such as when a vehicle transmission has been in the neutral gear position for longer than a threshold time, it may be desirable to prevent shifting out of neutral without the driver taking some prerequisite action prior to rotating the selector 12. This is a so-called neutral lock. Such driver action may be applying the brake or pushing a button, for example. Upon detection that the transmission has been in neutral for longer than the threshold time, the actuator 62 may be commanded to move the retainer 64 to a position in which one or more of its control features 80 prevent rotation of the second body 52. And upon detection of the prerequisite driver action to shift out of neutral, the actuator 62 may drive the retainer 64 to a position that permits the second body 52 to be rotated relative to the retainer 64 so that the selector 12 may be rotated to shift the transmission.

In at least some implementations, the retainer control features 80 and selector control features 82 include opposing surfaces that, when aligned, are axially and radially overlapped so that rotation of the selector 12 is prevented. The control features 80, 82 may include some combination of blocking members and voids (more particularly, surfaces that define the voids), wherein a blocking member may be received at least partially in a void or space defined by control features when it is desired to prevent rotation of the selector. In the example shown, the retainer includes the blocking members and the second body includes the voids, as is described further below. But other arrangements may be used including providing the second member with one or more blocking members and the retainer with one or more voids, or some combination of these.

In the example shown, the retainer 64 has a first control feature or first blocking member 84 that has oppositely facing surfaces that extend axially and radially (relative to the axis 20 of the second body 52). Other control features may also be provided to interact with different portions of the knob and/or its second body, as desired. The first blocking member 84 may be arranged radially within the periphery of the second body 52 in at least some positions of the retainer 64. The blocking member 84 may be provided in the same piece of material as the body 65 of the retainer 64 which may include a portion that is engaged with the spindle 72, and a portion engaged with the guide members 76, and the retainer may thus be defined in a single, unitary body having multiple features in a single piece of material, if desired. Instead of a single piece of material, all of the features may be provided in a body when the body is formed, and inserts or the like may be provided in the body to define one or more of the features or for other reasons, as desired. That is, in at least some implementations, the body may be formed from or include more than one material and still include integral features provided when the body is formed. Still further, the body could include portions added to it after the body is formed, and coupled to the body such as by a fastener. The portions of the body move together as driven by the actuator.

As shown in many figures and labeled in FIGS. 7 and 9, in more detail, the second body 52 has a first control feature that includes at least one stop surface 89 that defines at least part of a first void 90 arranged to receive the blocking member 84 of the retainer 64 so that the blocking member and stop surface are radially overlapped. Two stop surfaces 89 that define the first void 90 are shown as extending from the lower face 58 of the second body 52 and having a radial length and axial height. When the first tab 84 is radially aligned with and received at least partially in the first void 90, rotation of the second body 52 is prevented by engagement of the stop surfaces 89 with the retainer (e.g. its blocking member 84). In at least some implementations, the blocking member 84 is circumferentially aligned with the first void 90 when the selector is in the park position.

In at least some implementations, the second body 52 may include a second control feature that includes opposed stop surfaces 91 (FIGS. 11 and 13) circumferentially spaced apart to define a second void 92 between them. Like the first void 90, the stop surfaces 91 of the second void 92 are shown as extending from the lower face 58 of the second body 52 and have a radial length and axial height. When the blocking member 84 is received in the second void 92, rotation of the second body 52 is prevented. In at least some implementations, the second void 92 is radially inwardly spaced and circumferentially offset from the first void 90, and is circumferentially aligned with the blocking member 84 when the selector is in a position other than park, for example, the neutral position.

Any desired number and arrangement of control features may be provided on the retainer 64 and second body 52 to provide desired control of the selector rotation. The control features could also be provided on the first body and the retainer 64 could interact with the first body as desired, or with another component that moves as the selector 12 is rotated.

In at least some implementations, a drive 96 or drive assembly (which for convenience may be called a drive assembly even if it includes just one drive member) may be carried by the retainer 64 and arranged to drive, during at least a portion of the movement of the retainer, the second shift member 66 that is selectively engageable with the selector 12. In at least some positions of the shifter, the drive assembly 96 drives the second shift member 66 to rotate the selector 12 and cause a corresponding transmission gear shift. This may be desirable in a number of situations. For example, if a vehicle is turned off without first rotating the selector to shift the transmission to park, it may be desirable to automatically shift the vehicle into park via the second shift member 66. The second shift member 66 could also or instead rotate the selector 12 to shift the transmission to neutral or some other position, as desired.

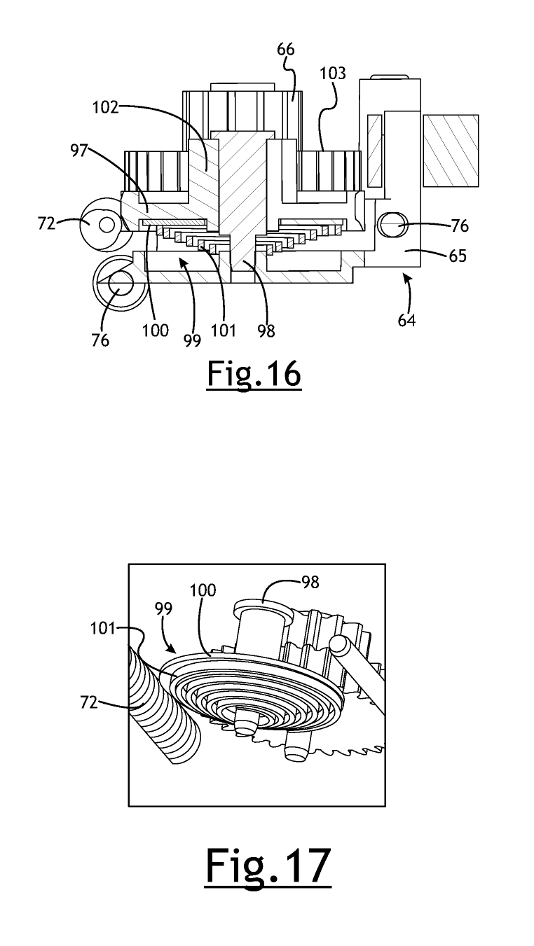

The drive assembly 96 may include a driven gear 97 that is meshed with the spindle 72, which may be called a drive gear, and which may be part of the drive or drive assembly 96 between the actuator and second shift member. The drive gear 97 may be carried by the retainer, such as by a first pin 98 fixed to or carried by the retainer. So that the driven gear 97 does not rotate when the spindle is rotated by the actuator 62, a device such as a brake or clutch is coupled to the driven gear. The brake or clutch may be any device suitable to selectively inhibit or prevent rotation of the driven gear 97, and permit rotation of the driven gear as noted herein. One example of a clutch 99 is shown in FIGS. 16 and 17, and includes a friction member 100 (shown as a thin, annular disc or plate) that is interposed between a spring 101 and the driven gear 97. The spring, in turn, bears on or is fixed at one end to the retainer body 65 and provides a force on the friction member to resist rotation of the driven gear. In this way, in at least some positions of the retainer 64, rotation of the spindle 72 does not cause rotation of the driven gear 97. Instead, the driven gear 97 translates along the spindle 72 in one direction when the spindle is rotated clockwise and in the opposite direction when the spindle is rotated counterclockwise. This drives the retainer 64, which is coupled to the driven gear 97 by the first pin 98, along the guide members 76 and closer toward and farther away from the axis 20 of the selector 12. In this way, the retainer 64 and driven gear 97 are coupled together for translation relative to the selector 12 as driven by the actuator 62.

When the retainer 64 reaches an end of its travel in at least one direction, the retainer may engage the housing 14 or some other stop surface. Further rotation of the spindle 72 in that direction does not result in further translation of the retainer 64. Instead, the force from the spindle 72 on the driven gear 97 overcomes the clutch 99 and the driven gear rotates relative to the clutch and the first pin 98. The rotation of the driven gear 97 can be used to drive the second shift member 66 and cause a shift of the selector 12, as set forth in more detail below. Instead of the clutch 99, as noted above, a brake, which may be mechanically or electrically controlled (e.g. by an electromagnet) can be used, among other devices. For convenience, the term clutch may be used herein to mean any device that selectively inhibits or prevents rotation, such as of the driven gear.

The driven gear 97 may be directly coupled to the second shift member 66, or the drive assembly 96 may further include other gears arranged to provide a change in torque or rotational speed between the driven gear and the second shift member 66, as desired. In at least some implementations, the drive assembly 96 includes one or more stages of torque increasing gears within the torque path between the actuator 62 and second shift member 66 so that, for example, a smaller, lighter, less expensive and lower power actuator may be used to change the position of the selector 12. In the example shown, the drive assembly 96 includes a second gear 102 coupled to the driven gear 97 and carried by the first pin 98 for co-rotation with the driven gear about the pin 98. The second gear 102 may be meshed with a third gear 103, which may be larger and include more teeth to provide a torque increase between the second and third gears. The third gear 103 may be carried by a second pin 104 that is carried by the retainer 64 so that the third gear also moves with the retainer. The third gear 103 rotates about an axis (defined by the second pin 104) that is spaced from and parallel the axis of rotation of the driven gear 97 and second gear 102, and which may also be parallel to the axis 20 of the selector 12 and perpendicular to the axis of the drive shaft 70 and spindle 72, if desired. The third gear 103 may be coupled to the second shift member 66 which may engage and rotate the selector 12, as set forth below.

With reference to FIGS. 3-6 and 8-15, in at least some implementations, the second shift member 66 is a fourth gear that is coupled to the third gear 103 for co-rotation with the third gear about the second pin 104, although other arrangements may be used. Thus, the second shift member 66 is also carried by the retainer for translation with the retainer 64 and relative to the selector 12. When the retainer 64 translates relative to the selector 12, the second shift member 66 is moved toward and away from the second body 52. The second body 52 may include outwardly extending teeth 106 along a portion of its radial periphery (e.g. in sidewall 60) and arranged to mesh with teeth of the second shift member 66 in at least one position of the retainer 64. In other positions of the retainer 64, the second shift member 66 may be unmeshed and not engaged with the second body 52, if desired. In such instances, the second body 52 may rotate without causing rotation of the second shift member 66.

The shifter 10 may include one or more position sensors to provide a positive indication of the position of one or more components, such as the retainer 64 and the selector 12. As shown in FIGS. 3, 5 and 6 (among others), a first sensor element may be coupled to the retainer 64 and is shown as including a magnet 114 received within a cavity of the retainer 64. A first sensor 116 (FIG. 2) may be carried by the circuit board 26, for example, and may be a hall-effect or other type of sensor responsive to movement of the magnet 114 as the retainer 64 moves. Of course, sensor types other than magnetic may be used, as desired, including but not limited to optical and contact based resistive sensors (e.g. potentiometers). A second sensor element may be carried by the selector 12 for rotation about the axis 20 when the selector rotates, to facilitate a determination of the rotary position of the selector. In the example shown, the second sensor element includes a magnet 118 (FIGS. 3, 5 and 6) that is fixed to the second body 52. A second sensor 120 (FIG. 2) may be carried by the circuit board 26, for example, and may be a hall-effect or other type of sensor responsive to movement of the second magnet as the second body rotates. Of course, sensor types other than magnetic field sensors may be used, as desired, including but not limited to optical and contact based resistive sensors (e.g. potentiometers). The first and second sensors 116, 120 may be coupled to the controller 28 so that the positions of the retainer 64 and second body/selector 12 can be determined during operation of the shifter 10.

In at least some implementations, the shifter 10 may include one or more feedback surfaces 126 arranged to provide a variable resistance to selector rotation. In FIGS. 5 and 6, among others, the feedback surfaces 126 may be defined in the base 18 of the housing. The feedback surfaces 126 have circumferentially spaced apart peaks 128 and valleys 130 (labeled in FIG. 6 but shown in many figures) at different radial distances from the axis 20. In at least some implementations, the peaks 128 may be closer to the axis 20 than the valleys 130.

One or more than one follower 132 is arranged to slide along the feedback surfaces 126 during at least some rotation of the selector 12 to provide force feedback to a person rotating the selector. As shown in FIG. 6, the follower 132 may be carried by the second body and yieldably biased, such as by a spring 134, into engagement with the feedback surfaces, or the follower 132 may be flexible and resilient, to permit the follower 132 to remain engaged with the feedback surfaces 126 as the second body is rotated. In at least some examples with a spring 134, the spring is compressed more when the follower 132 is aligned with a peak than when the follower 132 is aligned with a valley, and a greater force is needed to rotate the selector when the follower 132 moves over a peak than when the follower 132 moves into a valley. A resilient follower is itself compressed when aligned with a peak and may resiliently return to or toward an uncompressed state when aligned with a valley. The variation in force needed to rotate the selector 12 that is created by these force feedback surfaces 126 assists the user in finding a desired position, and also in retaining the selector 12 in a selected position as an increased force is needed to remove the follower 132 from a valley 130 (doing so requires more compression of the spring 134 or compression of the follower 132).

In at least some implementations, the valleys 130 may each correspond to a respective one of the various positions of the selector (that is, a first valley corresponds to the park position, a second valley corresponds to the reverse position, a third valley corresponds to the neutral position and a fourth valley corresponds to the drive position). An increased force may be needed to pass the follower 132 over a peak 128 between adjacent valleys 130, and then a spring or other return force acting on or provided by the follower 132 may tend to assist selector rotation toward a valley as the follower 132 rides along an inclined portion of a feedback surface 32 between a peak 128 and valley 130.

The operation of the shifter 10 will now be described. In FIGS. 3, 6 and 7, the shifter 10 is shown in a park lock position. In this position, the selector 12 is in a first position that corresponds to the transmission being in park, and the retainer 64 is in a first position in which the retainer prevents rotation of the selector 12. In more detail, in the position shown, the blocking member 84 of the retainer 64 is received in the first void 90 of the second body 52. So arranged, rotation of the selector 12 is prevented by engagement of the second body 52 with the blocking member 84. While the first void 90 is shown as including opposed stop surfaces 89, rotation of the selector 12 in one direction may be blocked by engagement of the selector with a separate stop surface, for example, a stop surface defined by the housing or another component. Accordingly, the selector 12 may only be rotated in one direction out of the park position, and the first void 92 may be arranged to prevent rotation of the selector in that direction without need for a second stop surface 89, if desired.

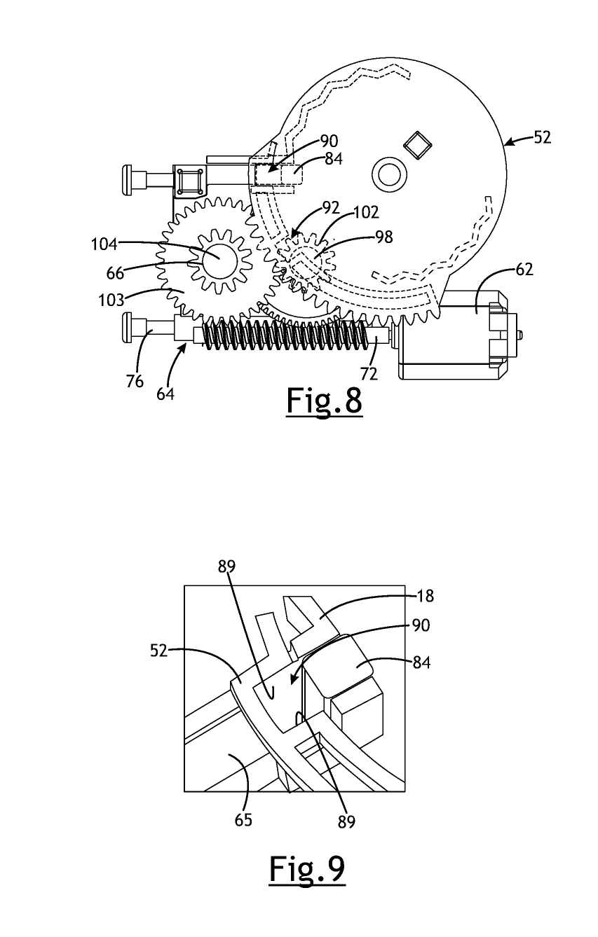

To permit rotation of the selector 12 out of the park position, the actuator 62 is commanded to move the retainer 64 away from the first position, to a second position in which the retainer does not prevent rotation of the selector. That is, the blocking member 84 is moved out of and is radially spaced from the first void 90, which can be seen by comparison of FIGS. 6 and 7 with FIGS. 8 and 9. To do this, the actuator drives the spindle 72 and the clutch 99 holds the driven gear 97 against rotation so the retainer 64 and drive assembly 96 translate along the spindle and toward the second body 52 to the second position of the retainer 64. This moves the blocking member 84 radially inwardly (relative to the axis 20) and out of the first void 90. Movement of the retainer 64 to the second position may occur in response to the driver taking some prerequisite action, such as actuating a vehicle brake or otherwise. In this position of the retainer, the selector 12 may be rotated out of the park gear without the retainer 64 interfering or blocking rotation of the second body 52.

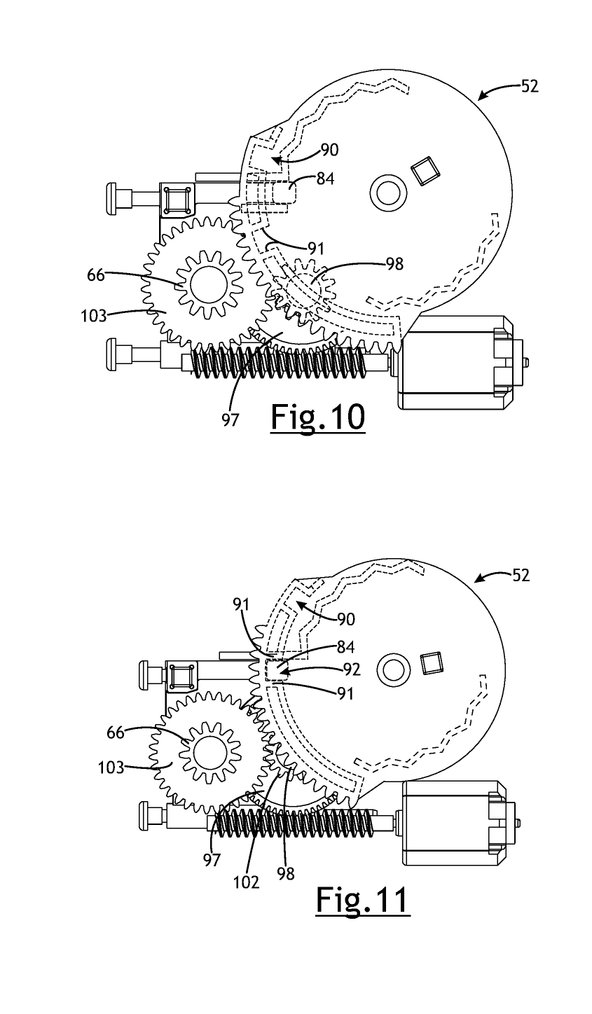

FIG. 10 illustrates the selector 12 in a second position wherein, due to rotation of the second body 52, the first void 90 is no longer aligned or registered with the blocking member 84. In this position of the shifter 10, the vehicle transmission is in reverse and the selector 12 may be rotated from the second position back to the first position or into a third position (corresponding to the transmission being in a forward drive gear.

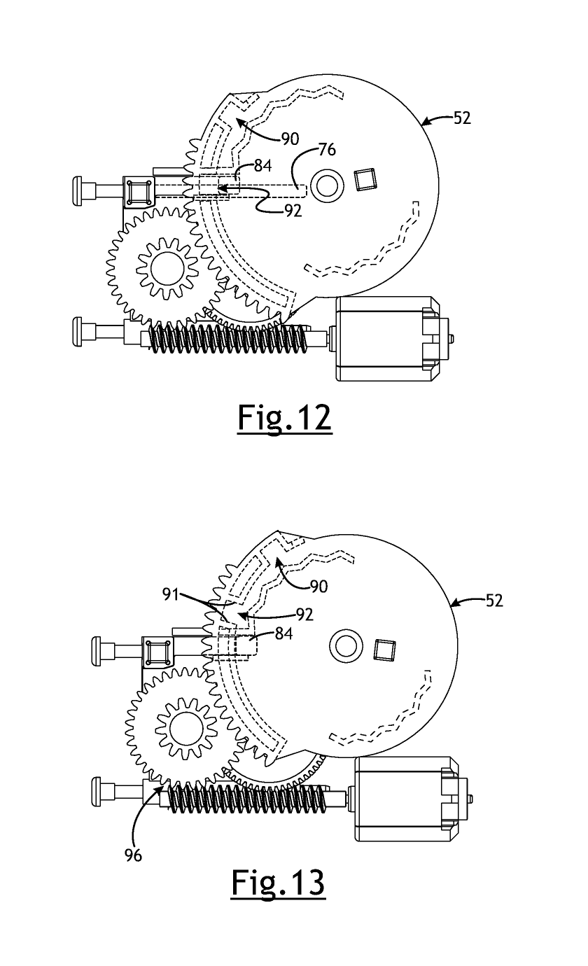

FIG. 12 illustrates the selector 12 in the third position and the retainer 64 in the second position. In this position of the shifter 10, the vehicle transmission is in neutral and the selector 12 may be rotated from the third position back to the second position or into a fourth position (corresponding to the transmission being in a forward drive gear). In at least some implementations, if one or more criteria are met, the controller 28 will cause the actuator 62 to move the retainer 64 relative to the second body 52 so that the retainer 64 blocks rotation of the selector 12 out of the third position. In FIG. 11, the retainer 64 is shown in its first position, wherein the blocking member 84 of the retainer 64 is received within the second void 92 and between the stop surfaces 91. In this position of the shifter 10, the selector 12 cannot be rotated to cause a transmission shift without the retainer 64 being moved to unblock rotation of the second body 52.

When the controller 28 actuates the actuator 62, the retainer 64 is moved from the first position to or toward the second position sufficiently such that the blocking member 84 is moved out of the second void 92. This may occur, for example, when the driver has actuated the vehicle brake or taken some other prerequisite action. After this retainer movement, the selector 12 can be rotated to the fourth position, as shown in FIG. 13, or to the second or first position.

In at least some implementations, when the selector 12 is in a position other than the first position, the selector 12 may be driven to the first position or back toward the first position by the actuator 62 acting on the second shift member 66 through the drive assembly 96. To do this, the retainer 64 is driven to a third position, which may be closest to the axis 20 of the selector 12 in at least some implementations.

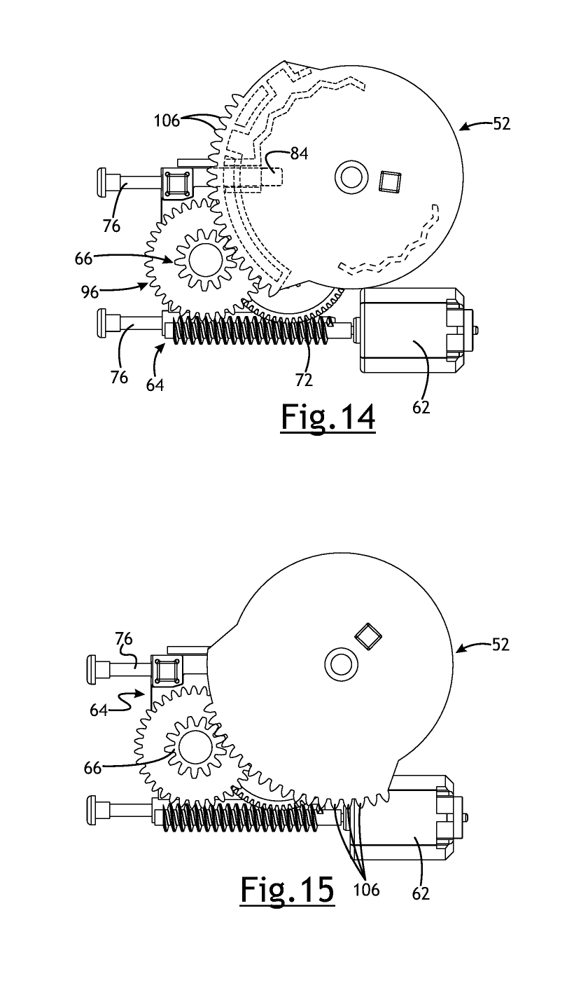

In this position, which is shown in FIG. 14, the retainer is at the end of its range of movement, and the second shift member 66 is meshed with the teeth 106 of the second body 52. Further driving of the spindle 72 in the corresponding direction will not result in further translation of the retainer 64. Instead, as noted above, the clutch 99 is overcome and the driven gear 97 is rotated which, through the rest of the drive assembly 96, drives the second shift member 66 for rotation about its axis. This in turn rotates the second body 52, and the selector 12 generally, about the axis 20.

In this way, the second body 52 and selector 12 may be rotated from the fourth position, through the third and second positions and to the first position (or rotation may be stopped at any position between the fourth and first positions). As the selector 12 reaches the first position, the first void 90 becomes aligned with the blocking member 84 and the shifter 10 is in the position shown in FIGS. 8 and 9. Driving the spindle 72 in the opposite direction can then be done to move the blocking member 84 into the first void 90, returning the shifter 10 to the position shown in FIGS. 6 and 7. This movement also disengages the second shift member 66 from the second body 52 to permit subsequent operation of the selector 12 without interference from the second shift member.

Of course, it may also be possible to move the shifter 10 to a different position other than the first position, such as the third position in which the transmission is in neutral. Instead, the shifter 10 could be driven/rotated in the opposite direction, e.g. from a lower numbered position to a higher numbered position by suitably arranged driving and cam surfaces (which may involve driving the retainer away from the actuator toward an extended position).

Accordingly, a second shift member 66 may selectively drive the selector 12 between and among the various positions of the selector. The second shift member 66 may be selectively engaged and disengaged from the selector 12 and the second shift member may be selectively driven to rotate the selector 12, as desired.

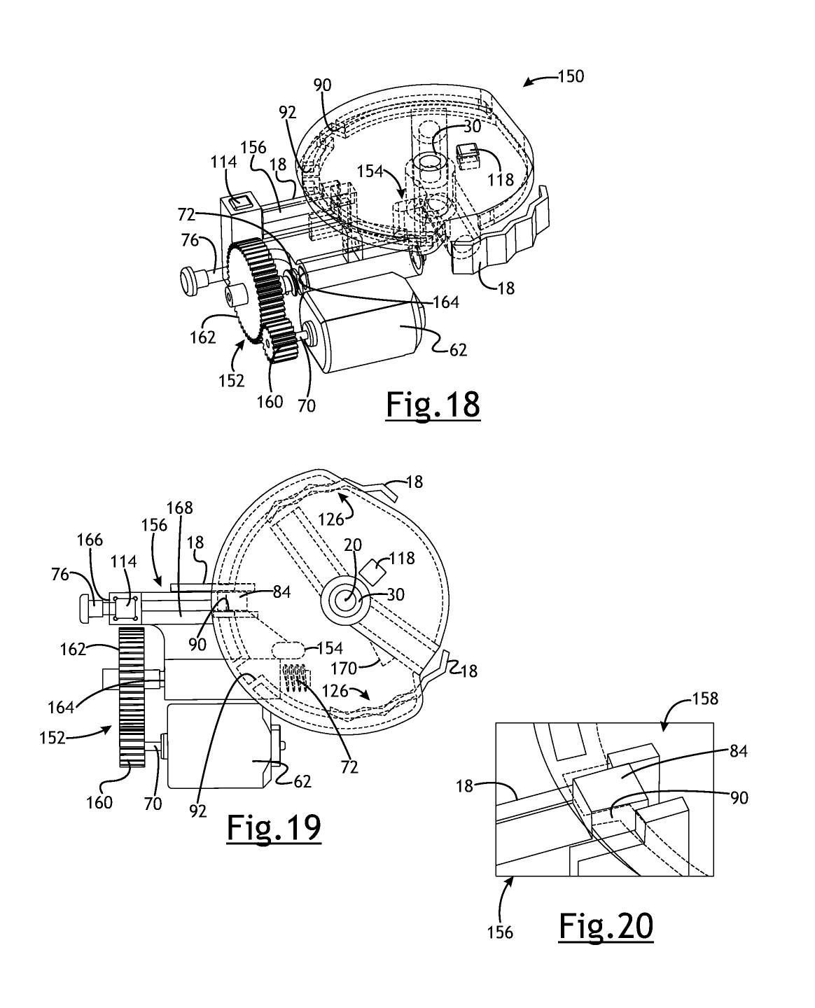

FIGS. 18-26 illustrate a portion of a modified shifter 150 that has a modified drive assembly 152 and second shift member 154. The remainder of the shifter 10, including the selector 12 may be the same as described above so most of the shifter 150 will not be separately described below. For ease of explanation and reference, parts that are the same as or similar to parts described above, will be given the same reference numbers.

In this implementation, the actuator 62 drives the retainer 156 for movement between first, second and third positions of the retainer. In the first position, the retainer 156 blocks rotation of the second body 158, and hence, the selector 12. This may be done with a blocking member 84 and voids 90, 92 with corresponding stop surfaces, as set forth above. In the second position, the retainer 156 permits rotation of the second body 158, and hence, the selector. In the third position, the retainer 156 causes the second shift member 154 to engage and rotate the second body 158 to cause a change in the position of the selector 12, as generally set forth above.

In more detail, the actuator 62 may directly drive the spindle 72 which may drive the retainer 156 among its positions, or the actuator may directly drive the retainer without any spindle (e.g. if the retainer moves linearly, the actuator may be a linear actuator directly coupled to the retainer, if desired). Or, as shown in the illustrated example, the drive or drive assembly 152 may be provided between the actuator and the retainer. The actuator 66 may directly drive a drive gear 160 (e.g. the drive gear may be coupled to or formed in the drive shaft 70) which may be coupled to a driven gear 162 which is coaxially coupled to the spindle 72. The driven gear 162 may be larger than the drive gear 160 and provide a torque increase between the drive gear and driven gear (more generally, between the actuator 62 and the retainer 156), if desired. The retainer 156, in the example shown, includes a threaded bore 164 in which the spindle 72 is received, and a passage 166 in which a guide member 76 is received. The threaded bore 164 may comprise a driven gear integrally formed in the body 168 of the retainer 156, or such a gear may be fixed to the retainer after the retainer body is formed. The guide member 76 may be spaced from and parallel to the spindle 72. In this way, the retainer 156 is constrained to linear movement among its positions. In the illustrated example, each gear 160, 162, 164, 72 rotates about an axis that is perpendicular to the axis 20 of the selector and parallel to the path of movement of the retainer 156. Of course, other arrangements to transfer torque along any desired path and angle(s) may be used, as desired.

In at least some implementations, the retainer 156 includes or drives the second shift member 154 that engages and rotates the second body 158. In the example shown, the second shift member 154 is integrally formed with the remainder of the retainer 154 (e.g. a feature provided when the retainer body 168 is formed), and comprises a portion of an outer surface of the retainer 156. The second body 158 includes an engagement surface 170 that is axially aligned with and in the path of movement of the second shift member 154, at least in some positions of the selector. In at least some implementations, the engagement surface 170 is within the path of movement of the second shift member 154 when the selector is in a position other than the first/park position. That is, in the illustrated embodiment, movement of the retainer 156 to its third position will engage the second shift member 154 with the engagement surface 170 and cause rotation of the selector back to the first/park position when the selector is in any position other than the first/park position. During this movement, the second shift member 154 remains engaged with the engagement surface 170 along a path (the second shift member moves linearly, the engagement surface rotates about the axis 20), and the engagement surface is arranged at a non-zero angle to the direction of movement of the second shift member 154 during at least part of the length of the path. The angled orientation of the engagement surface 170 increases the rotation of the selector for a given linear movement of the second shift member 154.

To better illustrate this, the operation of the device will now be described in more detail. In FIG. 19, the shifter 150 is shown in a park lock position. In this position, the selector 12 is in a first position that corresponds to the transmission being in park, and the retainer 156 is in a first position in which the retainer prevents rotation of the selector 12. In more detail, in the position shown, the blocking member 84 of the retainer 156 is received in a first void 90 of the second body 158. So arranged, rotation of the selector 12 is prevented by engagement of the second body 158 with the blocking member 84.

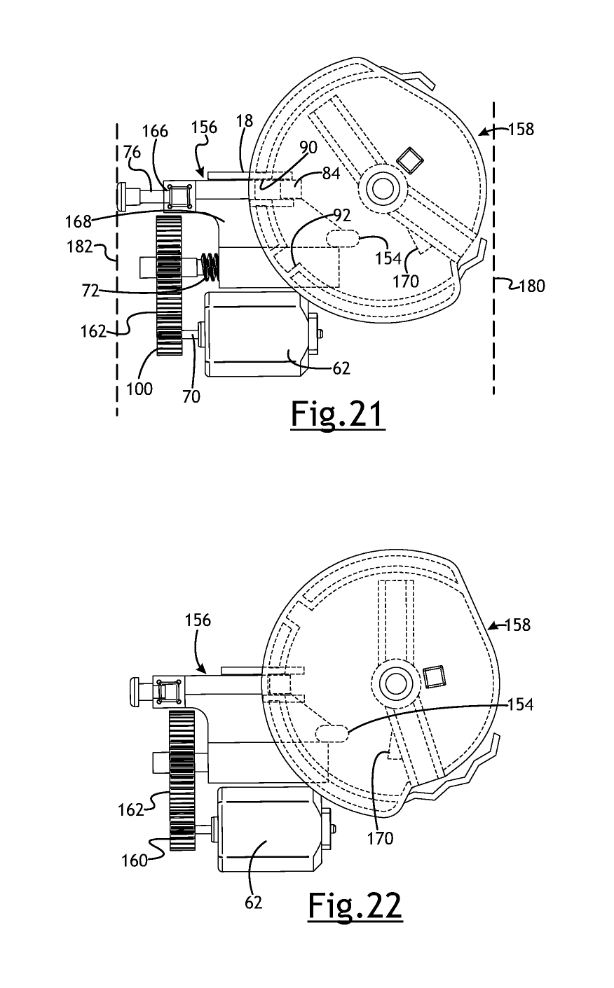

To permit rotation of the selector 12 out of the park position, the actuator 62 is commanded to move the retainer 156 away from the first position, to a second position in which the retainer does not prevent rotation of the selector. That is, the blocking member 84 is moved out of and is radially spaced from the first void 90, which can be seen by comparison of FIGS. 19-20 (which show the retainer in its first position) with FIGS. 18 and 21 (which show the retainer in its second position). To do this, the actuator 62 drives the spindle 72 and the retainer 156 translates along the spindle and toward the second body 158 to the second position of the retainer 156. This moves the blocking member 84 inwardly (e.g. toward the axis 20) and out of the first void 90. Movement of the retainer 156 to the second position may occur in response to the driver taking some prerequisite action, such as actuating a vehicle brake or otherwise. In this position of the retainer 156, the selector 12 may be rotated out of the park gear without the retainer interfering or blocking rotation of the second body 158.

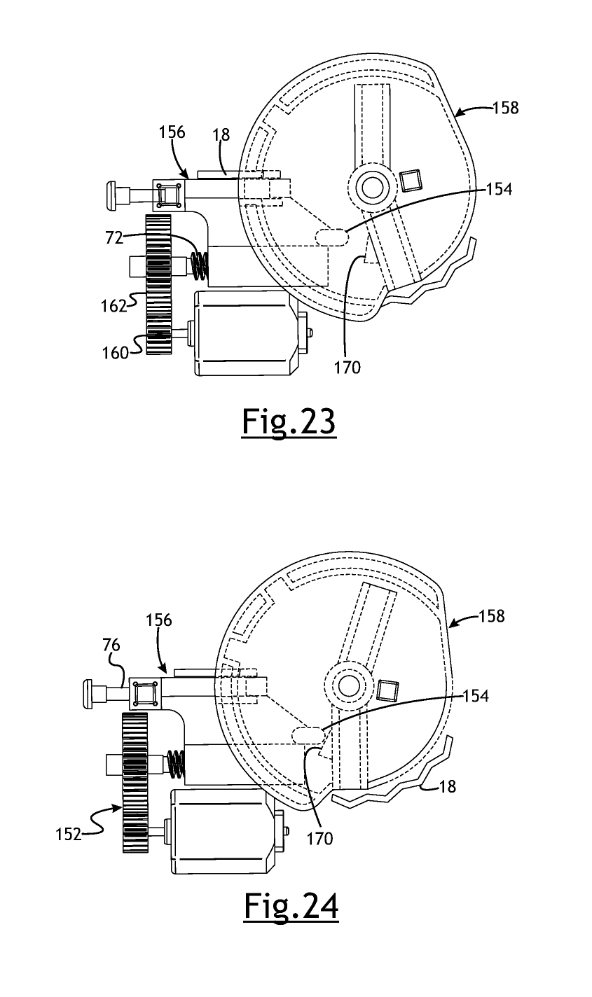

FIG. 23 illustrates the selector 12 in the third position and the retainer 156 in the second position. In this position of the shifter 150, the vehicle transmission is in neutral and the selector 12 may be rotated from the third position back to the second position or into a fourth position (corresponding to the transmission being in a forward drive gear). In at least some implementations, if one or more criteria are met, the controller 28 will cause the actuator 62 to move the retainer 156 relative to the second body 158 so that the retainer blocks rotation of the selector 12 out of the third position. In FIG. 22, the retainer 156 is shown in its first position, wherein the blocking member 84 of the retainer 156 is received within the second void 92 and between the stop surfaces 91. In this position of the shifter 150, the selector 12 cannot be rotated to cause a transmission shift without the retainer 156 being moved to unblock rotation of the second body 158.

From this neutral lock position, when the controller 28 actuates the actuator 62, the retainer 156 is moved from the first position to or toward the second position sufficiently such that the blocking member 84 is moved out of the second void 92. This may occur, for example, when the driver has actuated the vehicle brake or taken some other prerequisite action. After this retainer movement, the selector 12 can be rotated to the fourth position, as shown in FIG. 24, or to the second or first position.

In at least some implementations, when the selector 12 is in a position other than the first position, the selector 12 may be driven to the first position or back toward the first position by the actuator 62 and the second shift member 154. To do this, the retainer 156 is driven to a third position, which may be farther from the first position than the second position.

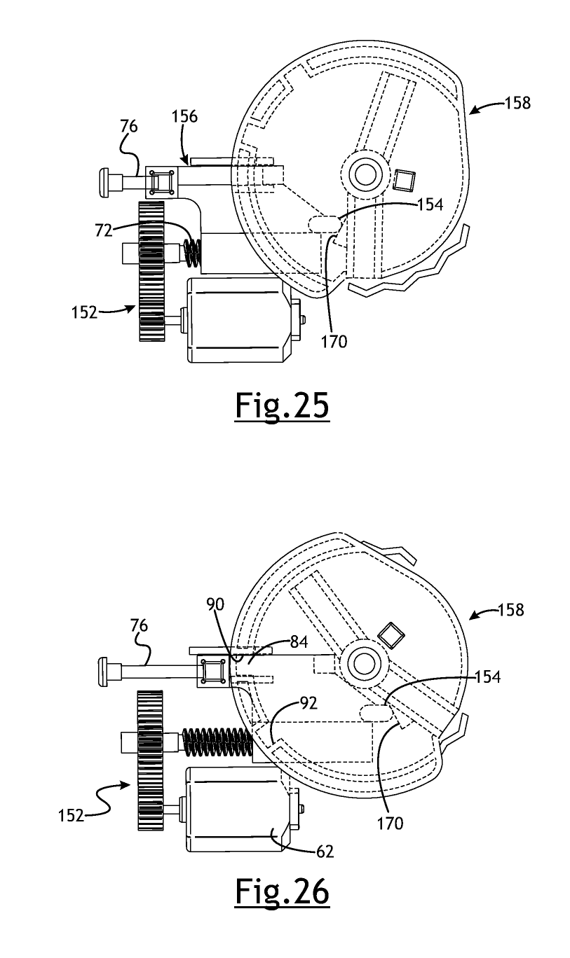

FIG. 25 illustrates an intermediate position of the retainer 156, between the second and third positions, wherein the second shift member 154 initially engages the engagement surface 170 of the second body 158. Further advancing the retainer 156 in the direction of the engagement surface 170 will cause the second shift member 154 to push the engagement surface and rotate the second body 158 about the axis 20. FIG. 26 illustrates the retainer 156 in the third position and the selector correspondingly returned to its first/park position. In this way, the second body 158 and selector 12 may be rotated from the fourth position, through the third and second positions and to the first position (or rotation may be stopped at any position between the fourth and first positions, and/or the rotation may start from a position other than the fourth position, as desired).

Thereafter, to permit future rotation of the selector by a user, the retainer 156 and second shift member 154 are retracted to or toward either the second or first position. When the second shift member 154 is used to drive the selector back to the first/park position, the retainer 156 may be drive back to its first position, returning the shifter 150 to the position shown in FIG. 19. In this position, rotation of the selector out of the first/park position cannot be done until the retainer is moved to its second position, as described above.

The shifter 10, 150 may have a shift position retainer 64, 156, a second shift member 66, 154 or both of these features. To selectively retain the position of the shifter, the shift position retainer may be selectively engaged with a rotating portion of the shifter to prevent rotation of the shift selector. To enable automatic shifting or movement of the selector (e.g. shifting by a powered actuator rather than manually by a person) the second shift member may be driven to rotate the shift selector from one position to another position. The second shift member may be driven linearly relative to the selector and arranged to push or pull a portion of the selector to rotate about its axis. The second shift member may instead be rotated relative to the selector to rotate the selector about its axis. A rotatable second shift member 66 may engage teeth 106 on a portion of the selector 12 (e.g. the second body 52) and the second shift member 66 may be translated into and out of engagement with the selector, as desired. Of course, other arrangements may be used.

A rotary actuator 62, such as an electric motor having a drive shaft 70 rotated by the motor, may be used to cause linear translation of the retainer 64, 156 between and among its positions. The second shift member 66, 154 may be carried by the retainer for movement relative to the selector. The second shift member 154 may be part of the retainer 156 such that the second shift member does not move relative to the retainer. Or, the second shift member 66 may be carried by the retainer 64 for movement with the retainer 64 relative to the selector 12 and also movable relative to the retainer to rotate the selector. An example of the latter arrangement is the fourth gear 66 which is carried by the retainer 64 for translation with the retainer and can also be rotated relative to the retainer to rotate the selector 12. Of course, other arrangements may be used, as desired.

In at least some implementations, a drive or drive assembly 96, 152 between the actuator 62 and the retainer 64, 156 may include a gear rotated about an axis that is parallel to the path of movement of the retainer. In the examples shown, the spindle 72 and the actuator and its output (e.g. drive shaft 70) are arranged parallel to the path of movement of the retainer. Of course, the actuator and one or more gears may be arranged at other angles, including perpendicular to the path of movement of the retainer, as desired.

In at least some implementations, the retainer 64, 156 is moved along a path in opposed first and second directions, and the actuator 62 may be received between two parallel planes 180, 182 (FIG. 21) arranged perpendicular to the movement path of the retainer and with a first plane at a radial periphery of the second body and a second plane at a radial outboard end of the retainer or drive (whichever terminates farthest from the axis 20). This provides a compact arrangement of the shifter, retainer and drive relative to the second body and selector in general, to provide a compact shifter.

While the forms of the invention herein disclosed constitute presently preferred embodiments, many others are possible. For example, while a second shift member was described as pushing the second body to rotate the selector, the second shift member may be arranged to pull the second body or a different part of the selector to rotate the selector. It is not intended herein to mention all the possible equivalent forms or ramifications of the invention. It is understood that the terms used herein are merely descriptive, rather than limiting, and that various changes may be made without departing from the spirit or scope of the invention.

1. A shifter for a vehicle transmission, comprising:
a first shift member having a body rotatable about an axis among multiple positions;
a retainer movable relative to the body, the retainer being movable between a first position in which the retainer prevents movement of the body and a second position in which the retainer permits movement of the body;
an actuator coupled to the retainer to drive the retainer between the first position and second position; and
a second shift member coupled to the retainer for movement with the retainer relative to the body, and arranged to selectively engage and rotate the body.

2. The shifter of claim 1 wherein the second shift member is integral with the retainer and is moved along the same path as the retainer.

3. The shifter of claim 2 wherein the body includes an engagement surface arranged to be selectively engaged by the second shift member in at least one position of the body and in at least one position of the retainer.

4. The shifter of claim 2 wherein the retainer includes a body and the second shift member is defined by a surface of the body.

5. The shifter of claim 1 wherein the second shift member is a gear that is moved relative to the body as the retainer moves and which is selectively rotated to rotate the body.

6. The shifter of claim 5 wherein the body includes teeth and the second gear includes teeth that are selectively meshed with the teeth of the body.

7. The shifter of claim 1 which also includes a drive gear rotated by the actuator and a driven gear driven by the drive gear, the driven gear being coupled to the retainer to move the retainer relative to the body and relative to the drive gear.

8. The shifter of claim 7 which also includes a clutch coupled to the driven gear to selectively prevent rotation of the drive gear.

9. The shifter of claim 8 wherein the clutch is coupled to the retainer and to the driven gear and in at least one position of the retainer, the clutch prevents rotation of the driven gear and in at least one other position of the retainer the driven gear rotates.

10. The shifter of claim 7 wherein the driven gear rotates about an axis that is not parallel to the axis of the drive gear.

11. The shifter of claim 1 which includes a drive assembly having multiple gears arranged in a torque path between the actuator and the retainer to move the retainer relative to the body, and wherein at least one of the multiple gears is fixed to the retainer.

12. The shifter of claim 11 wherein said at least one of the multiple gears is formed integrally with a body of the retainer.

13. The shifter of claim 1 wherein the retainer and body include control features that are radially overlapped relative to the axis when the retainer is in the first position so that the retainer prevents rotation of the first shift member and are not radially overlapped when the retainer is in the second position so that the retainer does not prevent rotation of the first shift member.

14. The shifter of claim 3 wherein the second shift member remains engaged with the engagement surface along a path, and the engagement surface is arranged at a non-zero angle to the direction of movement of the second shift member during at least part of the length of the path.

15. The shifter of claim 11 wherein the multiple gears include at least two gears that provide an increase in the torque provided by the actuator.

16. A shifter for a vehicle transmission, comprising:
a first shift member having a body rotatable about an axis among multiple positions;
a retainer movable relative to the body, the retainer being movable between a first position in which the retainer prevents movement of the body and a second position in which the retainer permits movement of the body;
an actuator;
a drive coupled to the actuator and to the retainer to drive the retainer between the first position and second position; and
a second shift member carried by the retainer for movement with the retainer relative to the body, and arranged to selectively engage and rotate the body.

17. The shifter of claim 16 wherein the drive includes a drive gear directly driven by the actuator and a driven gear fixed to the retainer so that rotation of the drive gear causes linear translation of the retainer.

18. The shifter of claim 17 wherein during linear translation of the retainer, the drive gear translates relative to the drive gear but does not rotate.

19. The shifter of claim 18 which also includes a clutch coupled to the driven gear to prevent rotation of the driven gear in at least some positions of the retainer.

20. The shifter of claim 16 wherein the drive includes a gear rotated about an axis that is parallel to the path of movement of the retainer.

21. The shifter of claim 20 wherein the retainer includes a gear arranged coaxially with the gear.

22. The shifter of claim 17 wherein the drive includes at least two gears that provide an increase in torque within the torque path between the actuator and retainer.
